(19) United States
(12) Patent Application Publication
(10) Pub. No.: US 2026/0267163 A1
(43) Pub. Date: Sep. 10, 2026

(54) REDUCED DISTORTION FOR EYEWEAR

(71) Applicant: Vendel Alliance LLC, Los Alamos, NM (US)

(72) Inventors: Lorenzo Venneri, Los Alamos, NM (US); Giuseppe Venneri, Los Alamos, NM (US)

(73) Assignee: Vendel Alliance LLC, Los Alamos, NM (US)

(21) Appl. No.: 19/161,079

(22) PCT Filed: Mar. 13, 2024
(86) PCT No.: PCT/US2024/019653

§ 371 Date: Aug. 29, 2025

Related U.S. Application Data
(60) Provisional application No. 63/451,750, filed on Mar. 13, 2023.

(51) Int. Cl. G02C 7/02

(52) U.S. Cl. CPC G02C 7/022

(57) ABSTRACT

An eyewear device, eyewear system, and method thereof. The eyewear device includes at least one spherical lens that includes a substantially spherical surface and is configured to maintain a substantially constant distance between an eyeball of a wearer and the substantially spherical surface to reduce distortion in positioning of objects in a field of view of the wearer. The eyewear device further includes a wearer interface coupled to the at least one spherical lens and configured to couple the at least one spherical lens to a head of the wearer. The eyewear system includes a non-transitory computer-readable medium, including facial analysis programming. Execution of the facial analysis programming by a processor configures a computing device to generate a facial profile of contours of a face of the wearer (e.g., based on captured images) such that the at least one spherical lens can be the truncated to match the facial profile.

### CROSS-REFERENCE TO RELATED APPLICATIONS

This application claims priority to U.S. Provisional Patent Application No. 63/451,750, filed on Mar. 13, 2023, titled “Reduced Distortion for Eyewear,” the entire disclosure of which is incorporated by reference herein.

### TECHNICAL FIELD

The present subject matter relates to examples of an eyewear device, eyewear system, and method thereof. The eyewear device comprises at least one spherical lens that includes a substantially spherical surface and is configured to maintain a substantially constant distance between an eyeball of a wearer and the substantially spherical surface to reduce distortion in positioning of objects in a field of view of the wearer.

### BACKGROUND

Eyewear can be used to provide the wearer with corrective optics, eye protection, or an aesthetic function. In most cases, a glass or plastic is shaped in the form of an optic with a particular optical power and then attached to a frame which is affixed to the face by various means. Designs vary widely, driven by various functions of the eyewear.

Corrective optics primarily aim to undo the distortions caused by myopia, hypermetropia, or astigmatism and so must have some focusing power. The material and shape of the non-focusing optic are chosen to achieve certain fracture strength, chemical resistance, wavelength transmission, focusing power, and aesthetic.

In the case of non-focusing eyewear, the optic's shape constitutes two parallel surfaces bent in any variety of aesthetically motivated curves. The optic contour will typically match an average facial elevation profile with an offset and various aesthetic considerations. The curve of the optic surface might follow a facial profile viewed from above. In many cases, the design is manufacturing constrained so that the frame is easy to make and fit out of flat or nearly flat components, such as a lens.

### SUMMARY

In a first example, an eyewear device 100 includes at least one spherical lens 101A-B. The at least one spherical lens 101A-B includes a substantially spherical surface 102 and is configured to maintain a substantially constant distance 103 between an eyeball 104 of a wearer 105 and the substantially spherical surface 102 to reduce distortion 106 in positioning of objects 107A-N in a field of view 108 of the wearer 105. The eyewear device 100 further includes a wearer interface 109 coupled to the at least one spherical lens 101A-B and configured to couple the at least one spherical lens 101A-B to a head 110 of the wearer 105.

In a second example, an eyewear system 140 includes a non-transitory computer-readable medium 141, including facial analysis programming 142. Execution of the facial analysis programming 142 by a processor 143 configures a computing device 144 to generate a facial profile 145 of contours 129A-N of a face 130 of a wearer 105. The eyewear system 140 further includes an eyewear device 100 including a first spherical lens 101A and a second spherical lens 101B. The first spherical lens 101A and the second spherical lens 101B include a substantially spherical surface 102, are configured to maintain a substantially constant distance 103 between an eyeball 104 of a wearer and the substantially spherical surface 102 to reduce distortion 106 in positioning of objects 107A-N in a field of view 108 of the wearer 105, and are truncated to match the facial profile 145.

In a third example, a method 150 includes capturing, via facial analysis programming 142, a plurality of images 151A-N of a face 130 of a wearer 105 of an eyewear device 100. The method further includes generating, via the facial analysis programming 142, a facial profile 145 of contours 129A-N of the face 130 of the wearer 105 based on the plurality of images 151A-N. The method further includes providing an eyewear device 100 that includes at least one spherical lens 101A-B based on the facial profile 145. The at least one spherical lens 101A-B includes a substantially spherical surface 102 and is configured to maintain a substantially constant distance 103 between an eyeball 104 of the wearer 105 and the substantially spherical surface 102 to reduce distortion 106 in positioning of objects 107A-N in a field of view 108 of the wearer 105.

Additional objects, advantages, and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1 illustrates a flat lens for eyewear from the prior art that results in a distorted scene.

FIG. 2 illustrates a spherical lens with a substantially spherical surface for an eyewear device that results in a distortion-free scene.

FIG. 3A is a front view of an eyewear device that includes the spherical lens with the substantially spherical surface of FIG. 2.

FIG. 3B is a perspective view, FIG. 3C is a side view, and FIG. 3D is a top view of the eyewear device of FIG. 3A.

FIG. 4 is a perspective view of the eyewear device that includes the spherical lens of FIGS. 2 and 3A-D coupled to a head of a wearer.

FIG. 5A is a front view of an eyewear device of FIGS. 2, 3A-D, and 4 that includes the spherical lens coupled to the head of the wearer.

FIG. 5B is a perspective view, FIG. 5C is a side view, and FIG. 5D is a top view of the eyewear device of FIG. 5A that includes the spherical lens coupled to the head of the wearer.

FIG. 5E is a perspective view of a single spherical lens with a substantially spherical surface that is cut to match the contours of the face of the wearer.

FIG. 6A is an eyewear device method, such as a protocol, for an eyewear system that includes a computing device.

FIG. 6B is an eyewear device method, such as a protocol, for an eyewear system like that of FIG. 6A, but that further includes a secondary computing device.

FIG. 6C is a schematic of one of the blocks of the eyewear device methods (e.g. protocols) of FIGS. 6A-B.

FIG. 6D is a schematic of the other blocks of the eyewear device methods (e.g. protocols) of FIGS. 6A-B.

### PARTS LISTING

100 Eyewear Device
101, 101A-B Spherical Lenses
102, 102A-B Substantially Spherical Surface
103, 103A-C Substantially Constant Distance
104, 104A-B Eyeball
105 Wearer
106, 106A-N Distortion
107A-N Objects
108 Field of View
109 Wearer Interface
110 Head
111 Path Length
112A-N Light Rays
113 Original Scene
113A Distorted Scene
113B Distortion-Free Scene
114 Surface Shape
115 Optically Tinted or Transparent Material
116 Substantially Uniform Thickness
118 Frame
119 Nose
120, 120A-B Ears
122 Coupling Interface (e.g., Hole)
127 Eyebrow
129A-N Contours
130 Face
131 Diameter
132 Hemispherical Shape or a Truncated Portion Thereof
140 Eyewear System
141, 141A-B Non-Transitory Computer-Readable Medium (e.g., Memory)
142, 142A-B Facial Analysis Programming
143, 143A-B Processor
144 Computing Device
145 Facial Profile
146 Geometry
147A-N Facial Features
148 Lens Profile
150A-B Eyewear Device Method
151A-N Plurality of Images
160 Flat Lens
161 Flat Surface
162A-C Variable Distance
163A-N Distorted Objects
164A-B Nose Pads
165 Image Sensor (e.g. Camera)
166, 166A-B Network Communication Interface
167 Secondary Computing Device
168 Network(s)

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The term “coupled” as used herein refers to any logical, physical, or electrical connection. Unless described otherwise, coupled elements or devices are not necessarily directly connected to one another and may be separated by intermediate components, elements, etc.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The term “approximately,” “significantly,” or “substantially” means that the parameter value or the like varies up to ±25% from the stated amount.

When used in connection with a shape, the term “substantially spherical” means generally like a sphere or truncated sphere in being round, or nearly round, in three-dimensional space, for example, all points in three-dimensional space of the shape lie the same distance (e.g., the radius) from a given point (e.g., the center) within ±25%, so that the shape is apparently round so far as is perceptible. When used in connection with the “spherical lens,” the term “substantially parallel” means the two substantially spherical surfaces on opposing sides of the optic have the same distance continuously between within reasonable tolerances of ±25%. The term “substantially uniform thickness” means the thickness dimension is the same within reasonable manufacturing tolerances of ±25%, to appear of the same thickness throughout so far as is perceptible.

As used herein, the term “lens” is meant to cover transparent or translucent pieces of glass, plastic, etc. having curved and/or flat surfaces that cause little or no convergence or divergence or cause light to converge/diverge. The term “distortion-free” means mostly undistorted within reasonable tolerances of ±10%, so that the objects in a scene would appear undistorted to an observer and remain true to the correct positioning in an original scene.

As used herein, “substantially planar” means mostly flat or level within reasonable manufacturing tolerances of ±25%, to appear planar so far as is perceptible. When used in connection with a shape, the term “substantially flat” means mostly planar (e.g., in the form of a plane) or level within ±25%, so that the shape is apparently planar or slightly curved so far as is perceptible.

The orientations of the eyewear device 100, spherical lens 101A-B, associated components, and/or any complete devices or eyewear system 140 incorporating the eyewear device 100, such as shown in any of the drawings, are given by way of example only, for illustration and discussion purposes. In operation for a particular eyewear device 100 or eyewear system 140, the components may be oriented in any other direction suitable to the particular application of the eyewear device 100, for example upright, sideways, or any other orientation. Also, to the extent used herein, any directional term, such as lateral, longitudinal, up, down, upper, lower, top, bottom, side, left, and right are used by way of example only, and are not limiting as to direction or orientation of any eyewear device 100 or component of the eyewear device 100 constructed as otherwise described herein. Reference now is made in detail to the examples illustrated in the accompanying drawings and discussed below.

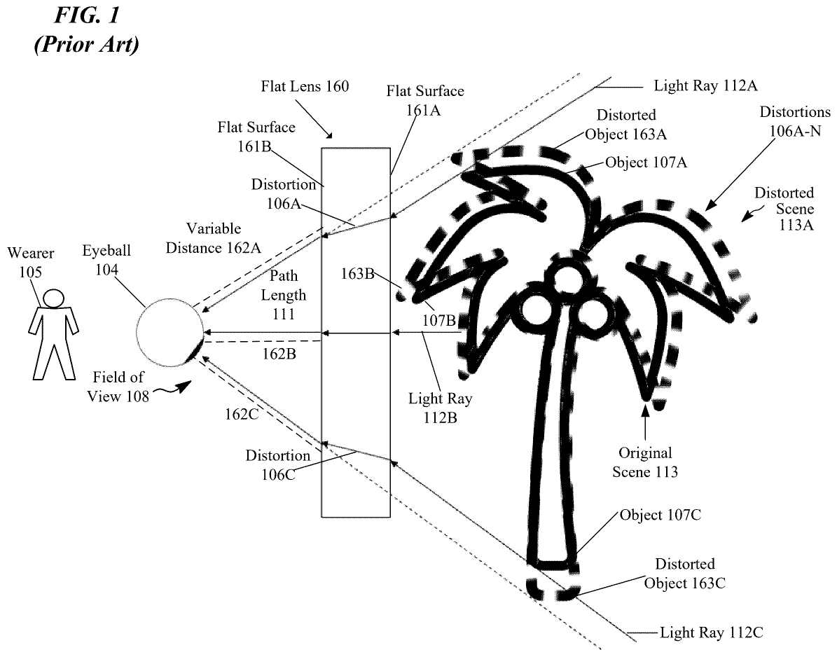

FIG. 1 illustrates a flat lens 160 for eyewear from the prior art that results in a distorted scene 113A. As shown in FIG. 1, a flat lens 160 that includes a flat surface 161 causes a variable distance 162A-C between an eyeball 104 of a wearer 105 and the flat lens 160. In the FIG. 1 example, two flat surfaces 161A-B are shown parallel to each other to form the flat lens 160. The solid lines outlining the palm tree is an original scene 113 as seen without the flat lens 160, and the broken lines outlining the palm tree is a distorted scene 113A as seen through the flat lens 160. As shown, the flat lens 160 includes a flat surface 161 (e.g., non-spherical shaped optic) that causes distortions 106A-N, meaning the objects 107A-N no longer remain true to their correct positioning when viewed through the flat lens 160.

In general, such conventional eyewear designs do not consider the scene distortions 106A-N caused by the use of a flat surface 161 or a substantially flat surface, even when the optic is non-focusing as in sunglasses and safety glasses. When comparing an original scene 113 with and without eyewear, the original scene 113 will appear distorted (e.g., distorted scene 113A) with conventional eyewear resulting in an incorrect world view and extra thinking strain to subconsciously correct the distortion 106. Without the conventional eyewear, the objects 107A-C (appearing in solid lines) would appear undistorted to an observer and remain true to the correct positioning in the original scene 113. However, when a wearer 105 puts on the conventional eyewear, the objects 107A-C appear as distorted objects 163A-C (appearing in broken lines), which no longer have fidelity to the true (e.g., correct) positioning in the original scene 113.

The implications are felt in many domains including cars, weapons, and sports. The brain of a wearer 105 of conventional eyewear has to compensate and adapt to the distorted vision. The distortions 106A-N arises from the changing orientation of an optic's normal with respect to the view vector of the eyeball 104 which changes a path length 111 of the scene 113 through the optic (e.g., flat lens 160). This changing orientation of the optic's normal translates the original scene 113 to the distorted scene 113A compared to the natural view of the original scene 113. The distorted scene 113A falsely positions the objects 107A-C providing an incorrect view to the wearer 105 of conventional eyewear.

As depicted in FIG. 1, a first incoming light ray 112A in a field of view 108 of the wearer 105 is refracted by the flat lens 160. Distortion 106A of the first light ray 112A is caused by a first variable distance 162A between the eyeball 104 of the wearer 105 and the flat lens 160. Hence, a first object 107A (palm tree leaf) appears as a first distorted object 163A, which is in an incorrect position relative to the true position in the original scene 113.

Similarly, second incoming light ray 112B in the field of view 108 of the wearer 105 is refracted by the flat lens 160. Distortion 106B of the second light ray 112A is caused by a second variable distance 162B between the eyeball 104 of the wearer 105 and the flat lens 160. Thus, a second object 107B (another palm tree leaf) appears as a second distorted object 163B, which is in an incorrect position relative to the true position in the original scene 113.

Finally, a third incoming light ray 112C in the field of view 108 of the wearer 105 is refracted by the flat lens 160. Distortion 106C of the second light ray 112C is caused by a third variable distance 162C between the eyeball 104 of the wearer and the flat lens 160. Accordingly, a third object 107C (palm tree trunk) appears as a third distorted object 163C, which is in an incorrect position relative to the true position in the original scene 113.

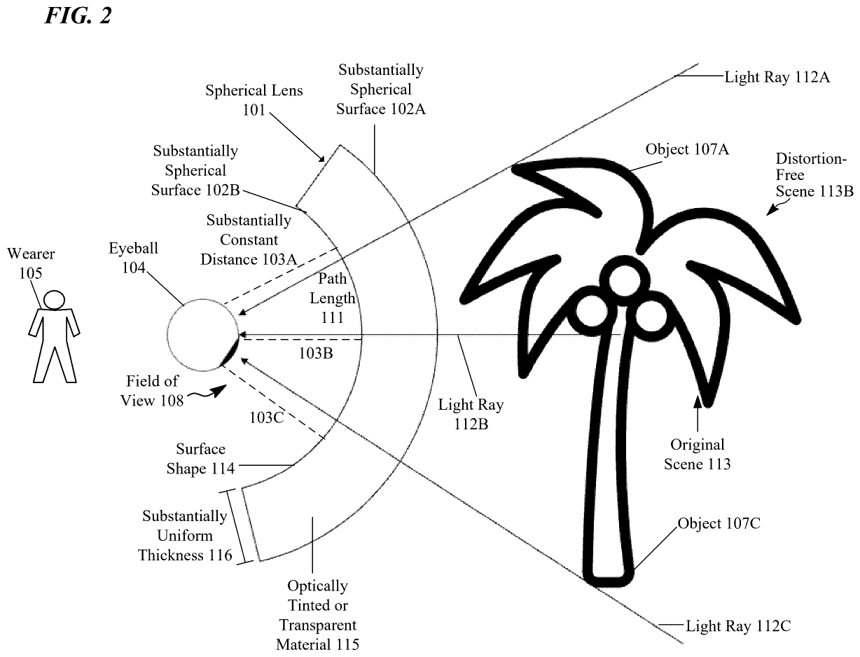

FIG. 2 illustrates a spherical lens 101 with a substantially spherical surface 102 for an eyewear device 100 that results in a distortion-free scene 113B. In the FIG. 2 example, two substantially spherical surfaces 102A-B are shown that are substantially parallel to each other to form the spherical lens 101. As shown, for the spherical lens 101, the original scene 113 appears the same with or without the substantially spherical surface 102 optic. Hence, the spherical lens 101 preserves the true position of objects 107A-N in the original scene 113 relative to each other.

In the example of FIG. 2, the spherical lens 101 can be formed of an optically tinted or transparent material 115 with a substantially uniform thickness 116. Although a substantially uniform thickness 116 can be a default option for the spherical lens 101, in some examples, the spherical lens 101 can be formed a non-uniform thickness to support a corrective type of eyewear device 100.

As depicted in FIG. 2, a first incoming light ray 112A in the field of view 108 of the wearer 105 is refracted by the spherical lens 101. Similarly, a second incoming light ray 112B in the field of view 108 of the wearer 105 is refracted by the spherical lens 101. Finally, a third incoming light ray 112C in the field of view 108 of the wearer 105 is refracted by the spherical lens 101.

All of the light rays 103A-C are undistorted when viewed through the spherical lens 101 of the eyewear device 100 by the wearer 105. This is because the substantially constant distances 103A-C between the eyeball 104 of the wearer 105 and the spherical lens 101 are approximately the same path length 111. Hence, the first object 107A (palm tree leaf), second object 107B (another palm tree leaf), and the third object (palm tree trunk) appear in their true and original position from the original scene 113 when viewed through the substantially spherical surface 102 optic. The spherical lens 101 can be configured to maintain the substantially constant distance 103A-C between the eyeball 104 of the wearer 105 by preserving path length 111 of light rays 112A-N that pass through from a scene 113 that is observed in the field of view 108. The spherical lens 101 can be configured to maintain the substantially constant distance 103A-C between the eyeball 104 of the wearer 105 by approximating a surface shape 114 of the eyeball 104 of the wearer 105.

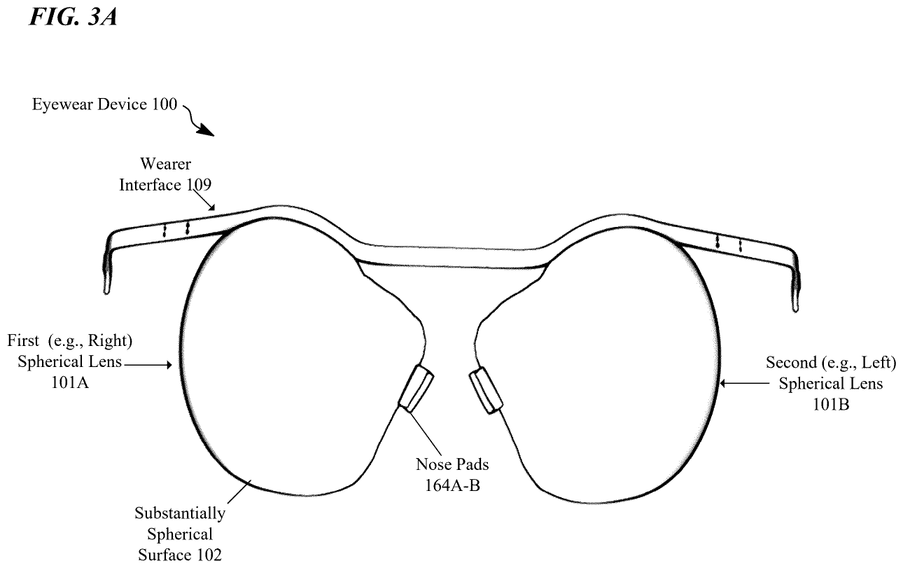

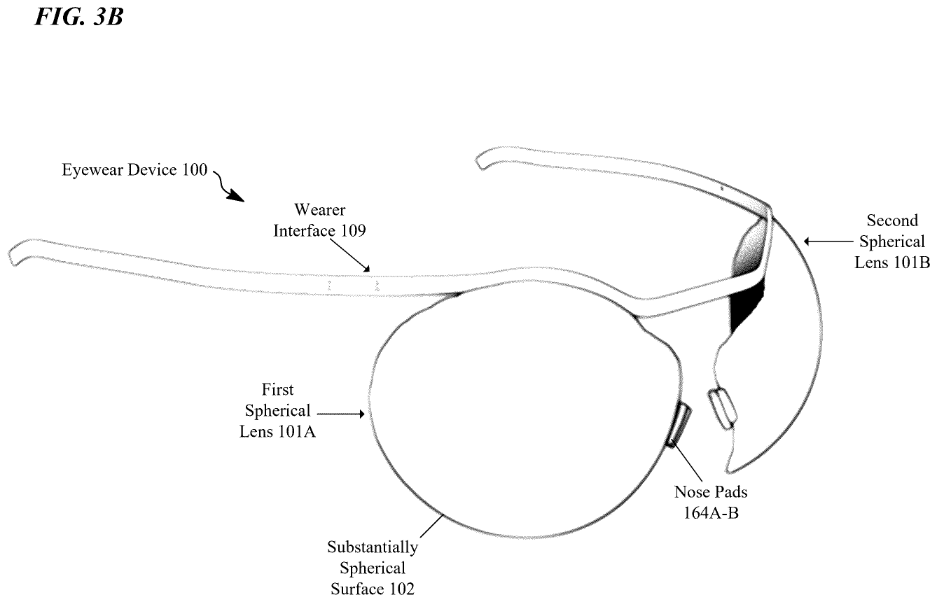

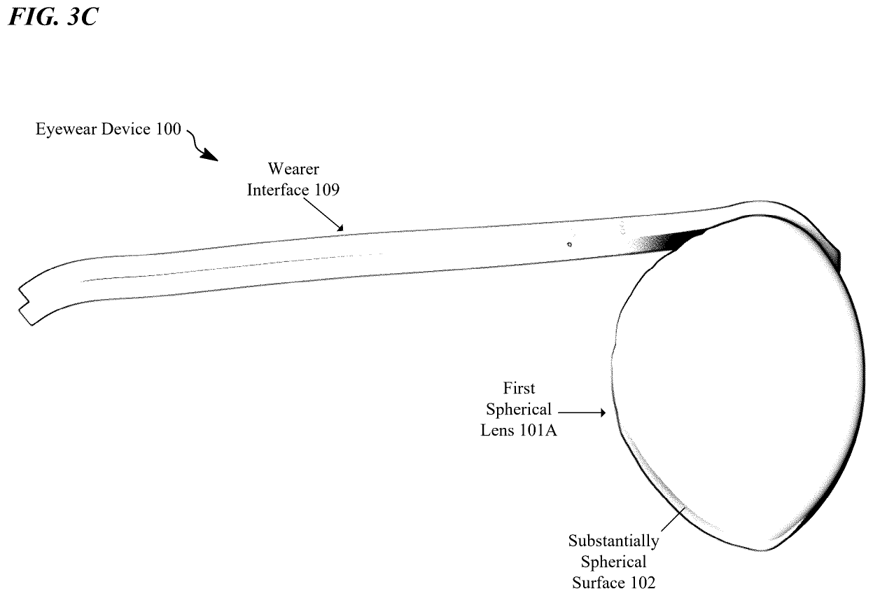

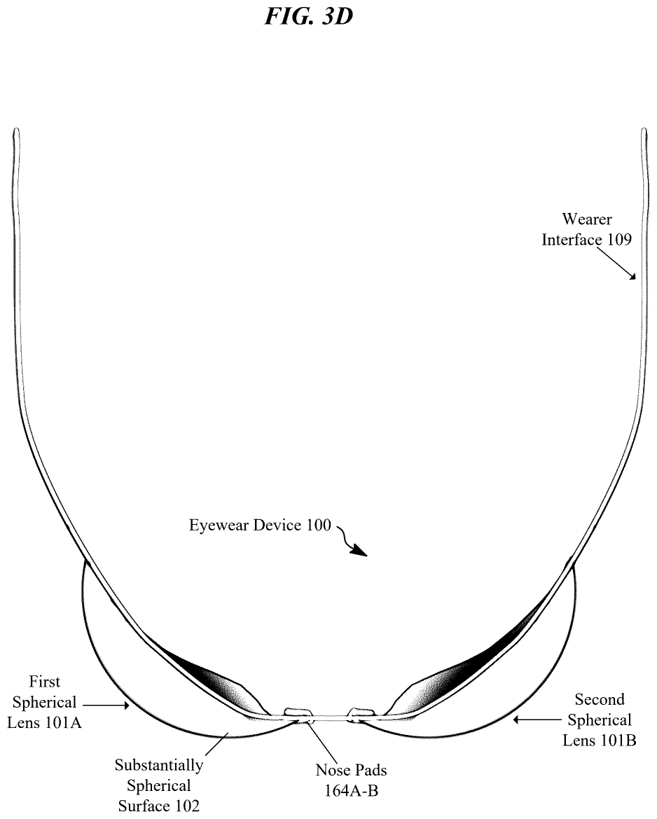

FIG. 3A is a front view of an eyewear device 100 that includes the spherical lens 101 with the substantially spherical surface 102 of FIG. 2. FIG. 3B is a perspective view, FIG. 3C is a side view, and FIG. 3D is a top view of the eyewear device 100 of FIG. 3A. Generally, the eyewear device 100 can include at least one spherical lens 101A-B. Although the examples herein depict two spherical lenses 101A-B, the eyewear device 100 can include a single spherical lens 101, such as a monocle, or a plurality of spherical lenses 101A-N.

Eyewear device 100 is in a form configured for wearing by a wearer 105, which are eyeglasses in the example. The eyewear device 100 can take other forms and may incorporate other types of frameworks, for example, a headgear, a headset, a helmet, or goggles.

In the example of FIGS. 3A-D, eyewear device 100 includes two spherical lenses 101A-B, such as a first (e.g., right) spherical lens 101A and a second (e.g., left) spherical lens 101B. The at least one spherical lens 101A-B includes a substantially spherical surface 102 and can be configured to maintain a substantially constant distance 103 between an eyeball 104 of a wearer 105 and the substantially spherical surface 102 to reduce distortion 106 in positioning of objects 107A-N in a field of view 108 of the wearer 105.

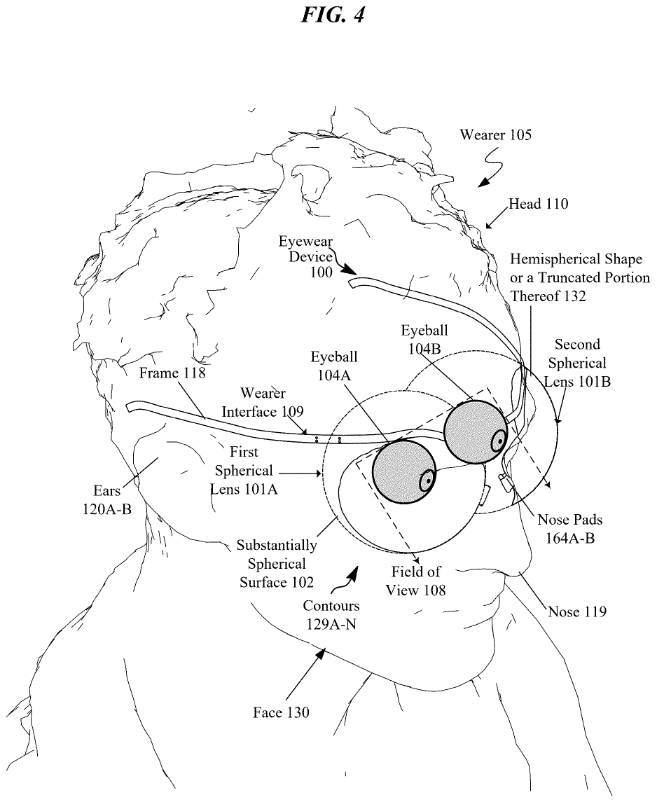

FIG. 4 is a perspective view of the eyewear device 100 that includes the spherical lens 101A-B of FIGS. 2 and 3A-D coupled to a head 110 of a wearer 105. Eyewear device 100 includes a first (e.g., right) spherical lens 101A and a second (e.g., left) spherical lens 101B. Generally, the right spherical lens 101A and the left spherical lens 101B can be a hemispherical shape or a truncated portion thereof 132. In other words, the right spherical lens 101A and the left spherical lens 101B can be a hemisphere which is cut to a facial profile 145 of the face 130 of the wearer 105. In the example of FIG. 4, the right spherical lens 101A and the left spherical lens 101B each include a substantially spherical surface 102 that is a truncated portion of a hemispherical shape.

Substantially spherical surface 102 is configured to be centered at the eyeball 104 of the wearer 105 of the eyewear device 100. The at least one spherical lens 101A-B can be a static optic, in other words, the position is at a fixed position with respect to the eyeball 104. In contrast, an adjustable optic, such as contact lenses are movable. The spherical lens 101 of the eyewear device 100 differs from a contact lens in various ways. The contact lens is a co-moving optic that moves with the eyeball 104, whereas the spherical lens 101 is a static optic that provides a similar level of a distortion-free scene 113B, but additionally provides many other benefits. The spherical lens 101, sits at a distance, which is a substantially constant distance 103, from the eyeball 104 and has all the advantages of non-contact eyewear. Namely, the spherical lens 101 can provide structural eye protection (e.g., from blasts, impact, chemical, etc.). The eyewear device 100 is easily put on or removed, and provides the opportunity for aesthetic design features, such as different profile cuts on the spherical lens 101, different frame 118 structures, and different diameter 131 of the spherical lens 101. However, in some examples, the spherical lens 101 may be incorporated into an adjustable type of eyewear device 100.

Eyewear device 100 can further include a wearer interface 109 coupled to the at least one spherical lens 101A-B and configured to couple the at least one spherical lens 101A-B to a head 110 of the wearer 105. As shown, the wearer interface 109 includes a frame 118 to contact a nose 119 and at least one ear 120 of the wearer 105 and configured to be located outside the field of view 108 of the wearer 105 to avoid interference. The contact with the nose 109 can be direct or indirect, for example, via nose pads 164A-B. The nose pads 164A-B can be thick pads from the spherical lens 101 optic to the nose 119 or pads with standoffs from the spherical lens 101 optic.

Hence, the eyewear device 100 can be protective, and yet minimize obstruction of the field of view 108. The support structures, such as the frame 118 and nose pads 164A-B can be formed of clear or semi-transparent material, such as plastic, to reduce the negative effects of obstruction of the field of view 108. The wearer interface 109 can utilize many other eyewear framing techniques to support the spherical lenses 101A-B of the eyewear device 100.

Eyewear device 100 in the example may also take other forms and therefore may incorporate still other types of frameworks. Another headgear type of form factor, for example, is a helmet. As noted, in the eyewear example, with two spherical lenses 101A-B, the frame 118 of the eyeglasses includes two lens frames as well. However, in a helmet example, the shell of the helmet serves as or forms at least part of the framework for the headgear type wearable user interface device. Accordingly, it should be understood that the eyewear device 100, including the spherical lenses 101A-B and the wearer interface 109, can also be embodied as other wearable devices, including a head-wearable device, such as a helmet, hat, headgear, goggles, etc.

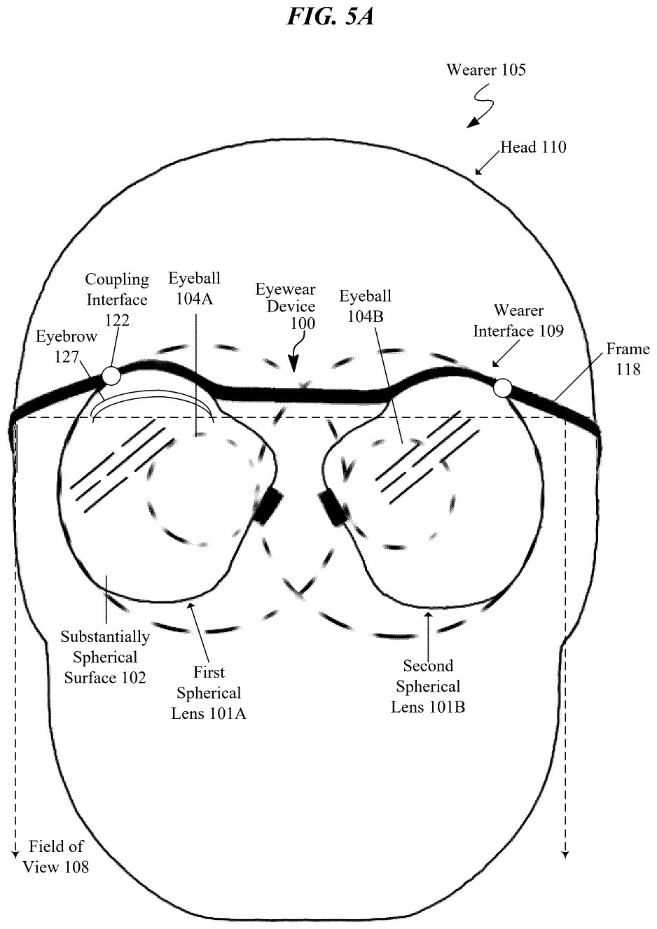

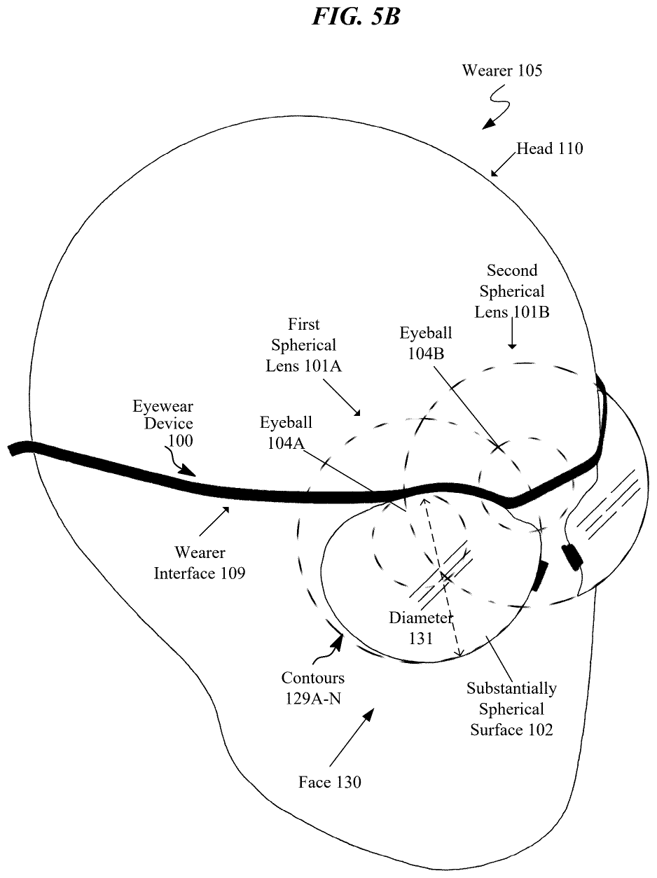

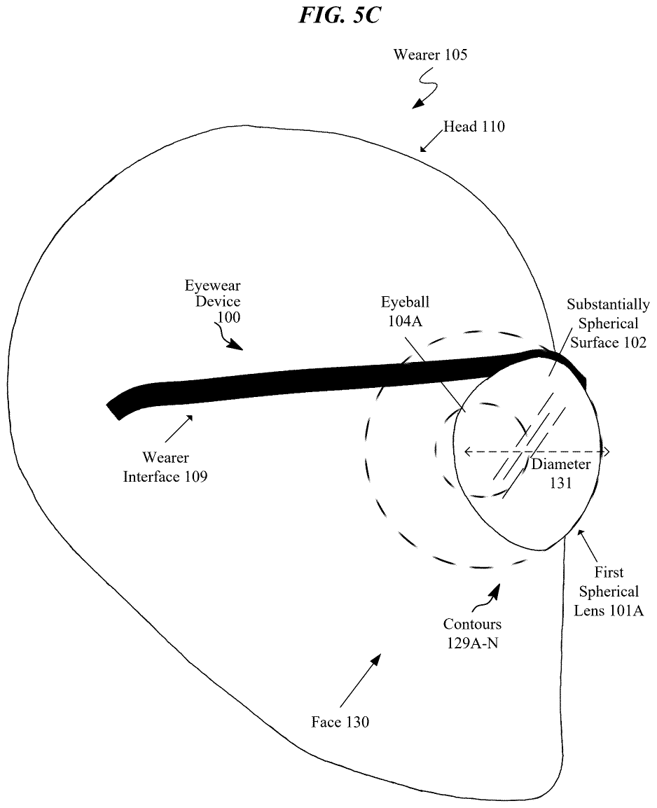

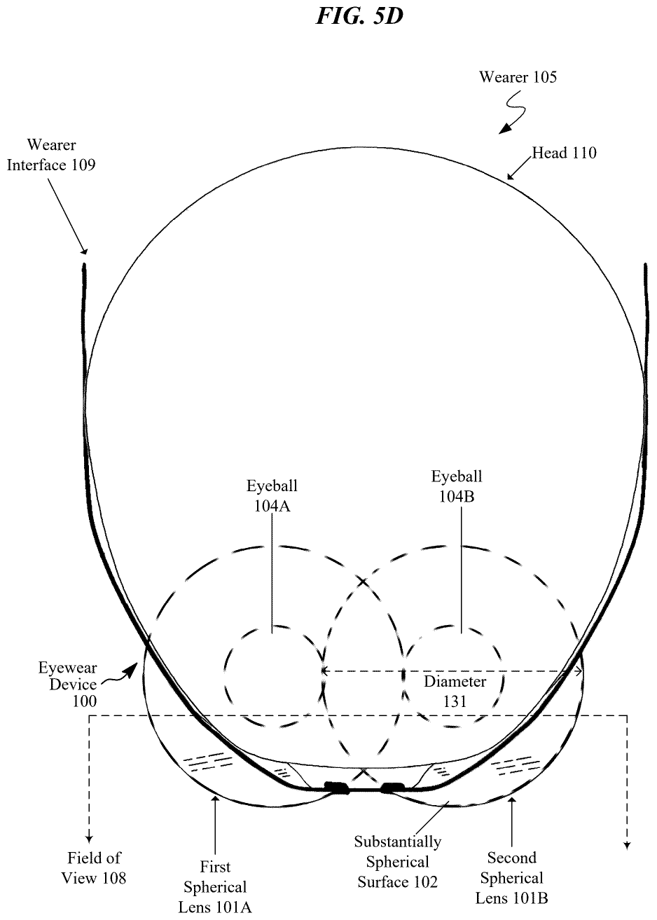

FIG. 5A is a front view of an eyewear device 100 of FIGS. 2, 3A-D, and 4 that includes the spherical lens 101 coupled to the head 110 of the wearer 105. The wearer interface 109 can be configured to be located outside the field of view 108 of the wearer 105 to avoid interference so that perception of the distortion-free scene 113B is not blocked. As shown in FIG. 5A, the at least one spherical lens 101A-B is configured to be placed over an eyebrow 127 of the wearer 105 to enable the wearer interface 109 to be located outside the field of view 108 and thereby eliminate obstruction of the field of view 108 so that viewing of the distortion-free scene 113B is unimpaired. This allows for further reduction in obstructions compared to other eyewear. Hence, the spherical lens 101 can extend above the eyebrow 127, depending on the diameter 131 chosen, and this area is outside of the field of view 108 of the eyeball 104.

The at least one spherical lens 101A-B can include at least one coupling interface 122 for coupling to the frame 118. For example, the coupling interface 112 can include a hole which is cut in the frame 118 by tooling. The framing connections and framing structure are located on the top of the spherical lens 101 optic, which is outside of the field of view 108. Therefore, the frame 118 and eyewear device 100 can eliminate obstruction of the field of view 108.

FIG. 5B is a perspective view, FIG. 5C is a side view, and FIG. 5D is a top view of the eyewear device 100 of FIG. 5A that includes the spherical lens 101 coupled to the head 110 of the wearer 105. As shown in FIGS. 5B-D, the substantially spherical surface 102 can be −N of a face 130 of the truncated to match contours 129A wearer 105. For example, a diameter 131 of the substantially spherical surface 102 is selected to match contours 129A-N of a face 130 of the wearer 105 and is then cut via a tool or machinery to match the contours 129A-N. The substantially spherical surface 102 can approximate the surface shape of the eyeball 104 and be scaled in size. The diameter 131 can vary and be somewhat arbitrary as long as the substantially spherical surface 102 conserves distance of eyeball 104 and spherical lens 101A-B by maintaining the substantially constant distance 103.

Eyewear device 100 can include a protective and aesthetic optic formed of non-focusing spherical lenses 101A-B centered on each eyeball 104A-B and cut to match the face 130 of the wearer 105. Each spherical lens 101A-B can include a substantially spherical surface 102, for example, and can be shaped as a substantially spherical shell that includes two substantially spherical surfaces 102A-B that are substantially parallel to each other to make the optic. Each spherical lens 101A-B can be formed of any optically transparent material, for example. Each spherical lens 101A-B is centered at the center of rotation of each eyeball 104A-B. Each spherical lens 101A-B can be held in place with respect to the face 130 by the wearer interface 109, which can include any number of mechanisms. Although the wearer interface 109 is a frame 118, in some examples, the wearer interface 109 can include various mechanisms for coupling to the head 110 of the wearer 105.

The spherical lens 101A-B can be uniquely cut to match a three-dimensional scanned facial profile 145 of the wearer 105. The spherical lens 101 of a certain diameter 131 is cut to match the face contours 129A-N with an offset to avoid touching as well as various aesthetic additions, such as extra cuts. The spherical lens 101 can also include extra cuts for a coupling interface 122, such as for supporting a wearer interface 109. The wearer interface 109 can include a frame 118 that contacts the ears 120A-B and nose-pads 164A-B that contact the nose 119.

The frame 118 can includes a right rim connected to a left rim via a bridge adapted for the nose 119 of the wearer 105. The right and left rims can include respective apertures which hold a respective spherical lens 101A-B.

In some examples, the eyewear device 100 can be configured as goggles. In the goggles example, the wearer interface 109 includes trim around a periphery of at least one spherical lens 101A-B and a band. The trim can be formed of a gasket material to form a border around the spherical lenses 101A-B. The band can be formed of elastic.

FIG. 5E is a perspective view of a single spherical lens 101 with a substantially spherical surface 102 that is cut to match the contours 129A-N of the face 130 of the wearer 105. This truncated spherical shape of the substantially spherical surface 102 can maintain a substantially constant distance 103 between an eyeball 104 of the wearer 105 of the eyewear device 100.

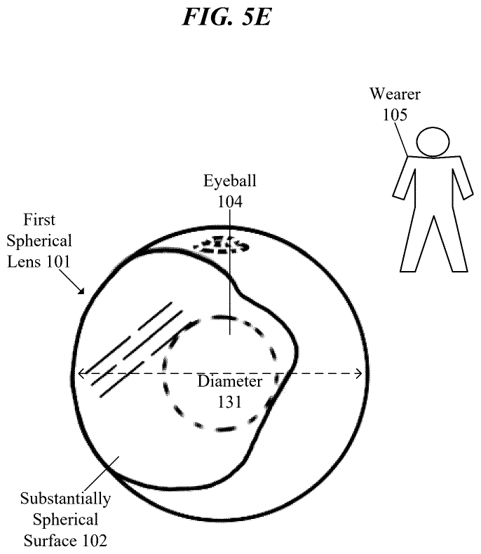

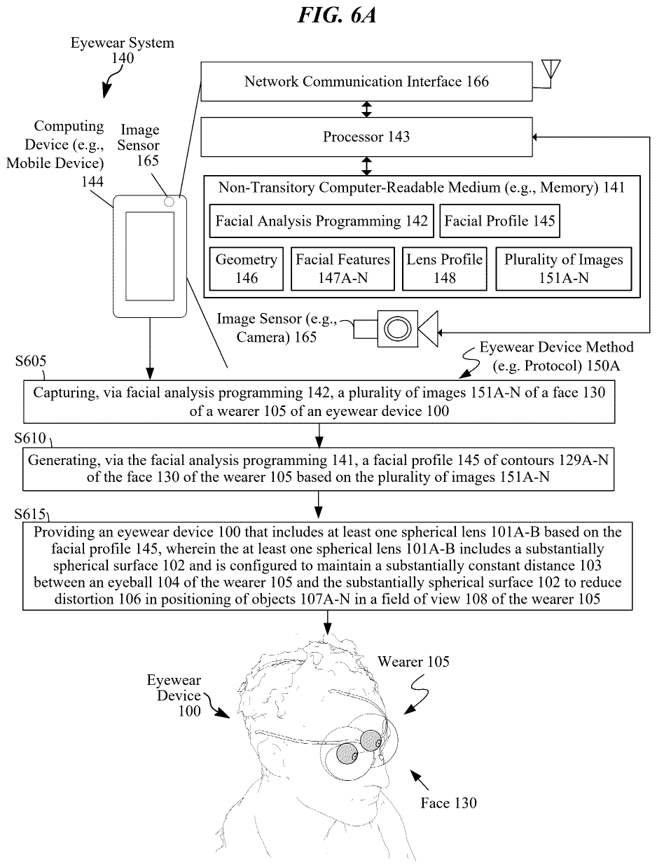

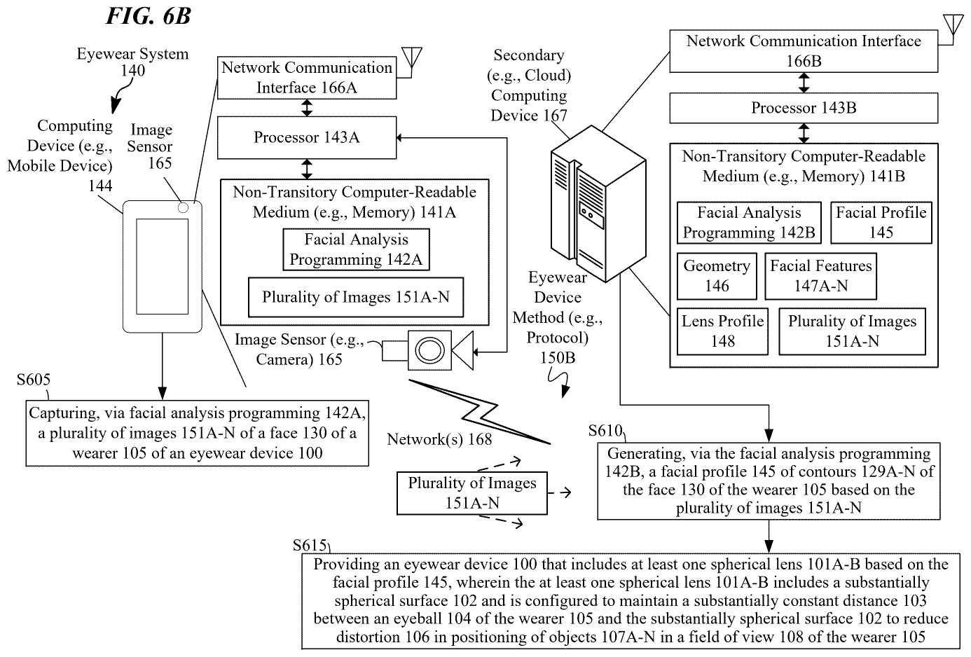

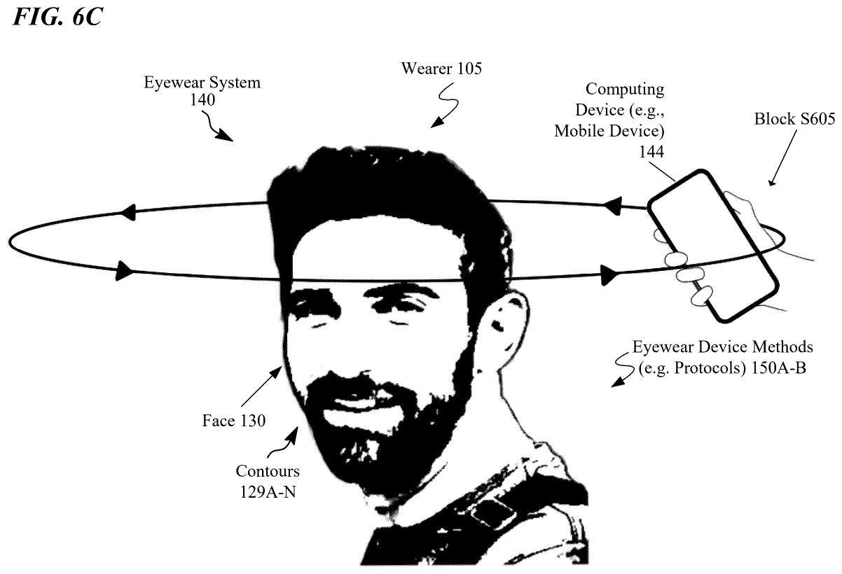

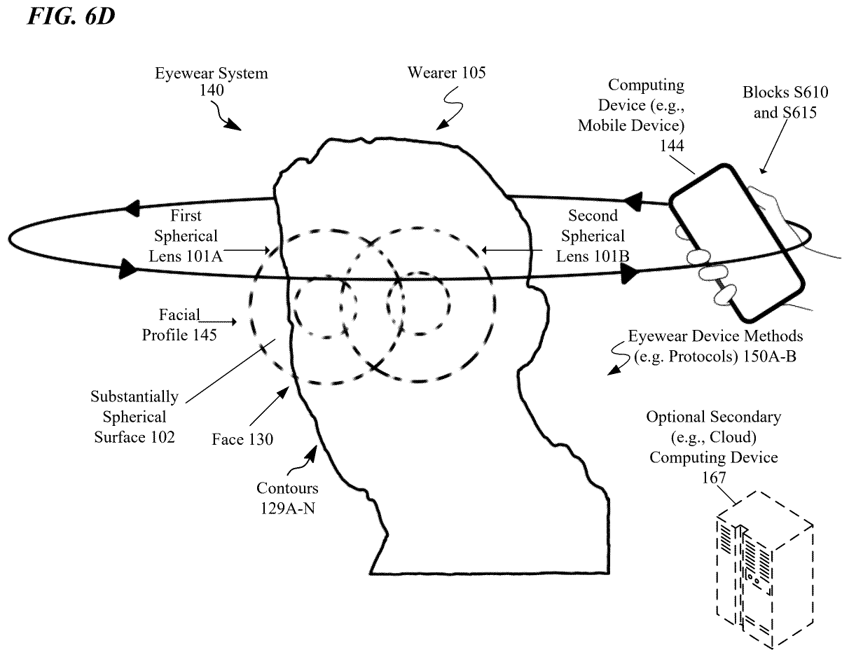

FIG. 6A is an eyewear device method 150A, such as a protocol, for an eyewear system 140 that includes a computing device 144. Eyewear device method 150A enables fitting of an eyewear device 100, including the spherical lenses 101A-B, to a shape of the face 130 of the wearer 105 to reduce distortion of objects 107A-N viewed through the spherical lenses 101A-B.

In the example of FIG. 6A, the eyewear system 140 includes the computing device 144 of a user (e.g., a human, such as the wearer 105). The computing device 144 can be any type of computing device, such as a mobile device (e.g., smartphone, tablet computing device, etc.), wearable (e.g., smart watch), laptop/personal computing device, a robot, etc. Computing device 144 includes a non-transitory machine readable medium (e.g., memory) 141, a processor 143, an image sensor 165, and a network communication interface 166 (e.g., wireless or wired). The non-transitory machine readable medium 141 includes facial analysis programming 142.

In FIG. 6A, the eyewear device method 150A is implemented in the facial analysis programming 142 of the computing device 144. Execution of the facial analysis programming 142 stored in a non-transitory computer-readable medium 141 by a processor 143 of the computing device 144 can cause the computing device 144 alone or in combination with other devices, equipment, tooling, machines, etc. to implement blocks S605, S610, and S615 described below.

Beginning in block S605, the eyewear device method 150A includes capturing, via facial analysis programming 142, a plurality of images 151A-N of a face 130 of a wearer 105 of an eyewear device 100. The plurality of images 141A-N can be captured via the image sensor 165, such as a camera, of the computing device 144. In the example of FIG. 6A, block S605 is implemented by the computing device 144.

Moving now to block S610, the eyewear device method 150A further includes generating, via the facial analysis programming 142, a facial profile 145 of contours 129A-N of the face 130 of the wearer 105 based on the plurality of images 151A-N. In the example of FIG. 6A, execution of the facial analysis programming 142 by the processor 143 configures the computing device 144 to generate the facial profile 145 of contours 129A-N of a face 130 of the wearer 105. The facial profile 145 can include a geometry 146 of one or more facial features 147A-N of the wearer 105. The one or more facial features 147A-N can include spacing between eyes (e.g., pupillary distance) 147A, nasal bridge width 147B, or spacing between ears 147C. The facial profile 145 can be a three-dimensional scanned facial profile or three-dimensional mesh. A diameter 131 and a lens profile 148 of the first spherical lens 101A and the second spherical lens 101B can be selected to match the facial profile 145.

Finishing now, in block S615, the eyewear device method 150A further includes providing an eyewear device 100 that includes at least one spherical lens 101A-B based on the facial profile 145. In the example of FIG. 6A, block S615 is implemented by the computing device 144 alone or in combination with other devices, equipment, tooling, machines, etc. to cut the spherical lenses 101A-B.

The at least one spherical lens 101A-B includes a substantially spherical surface 102 and is configured to maintain a substantially constant distance 103 between an eyeball 104 of the wearer 105 and the substantially spherical surface 102 to reduce distortion 106 in positioning of objects 107A-N in a field of view 108 of the wearer 105. The eyewear device 100 can further include a wearer interface 109 coupled to the first and second spherical lenses 101A-B and configured to couple the first and second spherical lenses 101A-B to a head 110 of the wearer 105.

In a first example, the step S615 of providing the eyewear device 100 can include truncating the substantially spherical surface 102 to match contours 129A-N of the face 130 of the wearer 105 based on the facial profile 145. In a second example, the step S615 of providing the eyewear device 100 can include selecting a diameter 131 of the substantially spherical surface 102 to match contours 129A-N of the face 130 of the wearer 105 based on the facial profile 145. In a third example, the step S615 of providing the eyewear device 100 can include three-dimensional printing at least one spherical lens 101A-B based on the facial profile 145. In a fourth example, the step S615 of providing the eyewear device 100 can include the following steps. First, forming (e.g., cutting) a coupling interface (e.g., a hole) 122 in at least one spherical lens 101A-B for a wearer interface 109 based on the facial profile 145 to enable the wearer interface 109 to be located outside the field of view 108 and thereby eliminate obstruction of the field of view 108. Second, coupling the wearer interface 109 to the eyewear device 100

FIG. 6B is an eyewear device method 150B, such as a protocol, for an eyewear system 140 like that of FIG. 6A, but that further includes a secondary computing device 167. In the example of FIG. 6B, the eyewear device method 150B is implemented in the facial analysis programming 142A of the computing device 144 and the facial analysis programming 142B of the secondary computing device 167. The secondary computing device 167 can be a separate computing device, such as a cloud computing device, server, personal computer, etc. that is separate from the computing device 144.

Execution of the facial analysis programming 142A stored in a non-transitory computer-readable medium (e.g., memory) 141A by a processor 143A of the computing device 144 causes the computing device 144 to implement block S605 as described earlier in FIG. 6A. Execution of the facial analysis programming 142B stored in a non-transitory computer-readable medium (e.g., memory) 141B by a processor 143B of the secondary computing device 167 causes the secondary computing device 167 alone or in combination with other devices, equipment, tooling, machines, etc. to implement blocks S610 and S615 as described earlier in FIG. 6A. However, the difference between the eyewear device method 150A of FIG. 6A and the eyewear device method 150B of FIG. 6B is that the computing device 144 transmits the captured plurality of images 151A-N of the face 130 of the wearer 105 to the secondary computing device 167 for processing.

Hence, beginning in block S605, the eyewear device method 150B includes capturing, via facial analysis programming 142A, a plurality of images 151A-N of a face 130 of a wearer 105 of an eyewear device 100. The plurality of images 141A-N can be captured via the image sensor 165, such as a camera, of the computing device 144. Block S605 of the eyewear device method 150B further includes transmitting, via a network communication interface 166A of the computing device 144 over a network 168 (e.g., wireless or wired), the plurality of images 151A-N.

Moving now to block S610, the eyewear device method 150B further includes receiving, via a network communication interface 166B (e.g., wireless or wired) of the secondary computing device 167, the plurality of images 151A-N from the computing device 144. From there, block S610 can proceed as previously described in FIG. 6A, but is implemented on the secondary computing device 167. Hence, in block S610 of the eyewear device method 150B, the secondary computing device 167 can generate, via the facial analysis programming 142B, a facial profile 145 of contours 129A-N of the face 130 of the wearer 105 based on the plurality of images 151A-N.

Finishing, in block S615 of the eyewear device method 150B, the secondary computing device 167 alone or in combination with other devices, equipment, tooling, machines, etc. can provide an eyewear device 100 that includes at least one spherical lens 101A-B based on the facial profile 145 as described in FIG. 6A. Block S615 proceeds as previously described in FIG. 6A.

FIG. 6C is a schematic of block S605 of the eyewear device methods (e.g. protocols) 150A-B of FIGS. 6A-B. As shown in FIG. 6C, the computing device 144 captures, via facial analysis programming 142, 142A-B, a plurality of images 151A-N of a face 130 of a wearer 105 of an eyewear device 100. From the captured plurality of images 151A-N, the facial profile 145 of contours 129A-N can be generated as shown in FIG. 6D.

FIG. 6D is a schematic of blocks S610 and S615 of the eyewear device methods (e.g. protocols) 150A-B of FIGS. 6A-B. As depicted in FIG. 6D, the computing device 144 or secondary computing device 167 can generate, via the facial analysis programming 142, 142A-B, a facial profile 145 of contours 129A-N of the face 130 of the wearer 105 based on the plurality of images 151A-N. Then, in block S615, the computing device 144 or secondary computing device 167 alone or in combination with other devices, equipment, tooling, machines, etc. can provide an eyewear device 100 that includes at least one spherical lens 101A-B based on the facial profile 145.

Any of the functionality of the eyewear device method (e.g. protocol) 150A-B, including facial analysis programming 142, 142A-B, described herein for the computing device 144, secondary computing device 167, etc. can be embodied in one more applications or firmware as described previously. According to some embodiments, “function,” “functions,” “application,” “applications,” “instruction,” “instructions,” or “programming” are program(s) that execute functions defined in the programs. Various programming languages can be employed to create one or more of the applications, structured in a variety of manners, such as object-oriented programming languages (e.g., Objective-C, Java, or C++) or procedural programming languages (e.g., C or assembly language). In a specific example, a third-party application (e.g., an application developed using the ANDROID™ or IOS™ software development kit (SDK) by an entity other than the vendor of the particular platform) may be mobile software running on a mobile operating system such as IOS™, ANDROID™ WINDOWS® Phone, or another mobile operating system. In this example, the third-party application can invoke API calls provided by the operating system to facilitate functionality described herein.

In the examples above, the computing device 144, secondary computing device 167, etc. each include a processor. As used herein, a processor 143, 143A-B is a hardware circuit having elements structured and arranged to perform one or more processing functions, typically various data processing functions. Although discrete logic components could be used, the examples utilize components forming a programmable central processing unit (CPU). A processor 143, 143A-B for example includes or is part of one or more integrated circuit (IC) chips incorporating the electronic elements to perform the functions of the CPU. The processors 143, 143A-B for example, may be based on any known or available microprocessor architecture, such as a Reduced Instruction Set Computing (RISC) using an ARM architecture. Of course, other processor circuitry may be used to form the CPU or processor hardware in. The illustrated examples of the processors 143, 143A-B can include one microprocessor or a multi-processor architecture. The processors 143, 143A-B can include one or more of any known general purpose processor or integrated circuit such as a central processing unit (CPU), microprocessor, field programmable gate array (FPGA), application specific integrated circuit (ASIC), digital signal processor (DSP), or other suitable programmable processing or computing device or circuit as desired that is specially programmed to perform operations for achieving the results of the examples described herein.

The applicable processor 143, 143A-B executes programming or instructions to configure the computing device 144, secondary computing device 167, etc. to perform various operations. For example, such operations may include various general operations (e.g., a clock function, recording and logging operational status and/or failure information) as well as various system-specific operations. Although a processor 143, 143A-B may be configured by use of hardwired logic, typical processors in computing devices are general processing circuits configured by execution of programming, e.g., instructions and any associated setting data from the memories 141, 141A-B shown or from other included storage media and/or received from remote storage media.

In the examples above, the computing device 144, secondary computing device 167, etc. each include a memory. The memory 141, 141A-B may include a flash memory (non-volatile or persistent storage), a read-only memory (ROM), and a random access memory (RAM) (volatile storage). The RAM serves as short term storage for instructions and data being handled by the processors 143, 143A-B, e.g., as a working data processing memory. The flash memory typically provides longer term storage.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

Hence, a machine-readable medium or a computer-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

In the examples above, the computing device 144, secondary cloud computing device 167, etc. each include a network communication interface 166, 166A-B for wired or wireless communication over one or more networks 168. The one more networks 168 interconnect the links to/from the network communication interfaces 166, 166A-B of the devices, so as to provide data communications amongst the computing device 144, secondary computing device 167, etc., for example, via a wide area network (e.g., Internet) or local area network (e.g., Intranet). The one more networks 168 may support data communication by equipment at the premises via wired (e.g. cable or fiber) media or via wireless (e.g. WiFi, Bluetooth, ZigBee, LiFi, IrDA, etc.) or combinations of wired and wireless technology.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain,” “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. An eyewear device, comprising:
at least one spherical lens that includes a substantially spherical surface and is configured to maintain a substantially constant distance between an eyeball of a wearer and the substantially spherical surface to reduce distortion in positioning of objects in a field of view of the wearer; and
a wearer interface coupled to the at least one spherical lens and configured to couple the at least one spherical lens to a head of the wearer.

2. The eyewear device of claim 1, wherein the at least one spherical lens is configured to maintain the substantially constant distance between the eyeball of the wearer by preserving path length of light rays that pass through from a scene that is observed in the field of view.

3. The eyewear device of claim 1, wherein the at least one spherical lens is configured to maintain the substantially constant distance between the eyeball of the wearer by approximating a surface shape of the eyeball of the wearer.

4. The eyewear device of claim 1, wherein the substantially spherical surface is configured to be centered at the eyeball.

5. The eyewear device of claim 1, wherein the at least one spherical lens is formed of an optically tinted or transparent material with a substantially uniform thickness.

6. The eyewear device of claim 1, wherein the at least one spherical lens is a static optic.

7. The eyewear device of claim 1, wherein the wearer interface includes a frame to contact a nose and at least one ear of the wearer and configured to be located outside the field of view of the wearer to avoid interference.

8. The eyewear device of claim 7, wherein the at least one spherical lens includes at least one coupling interface for coupling to the frame.

9. The eyewear device of claim 1, wherein the wearer interface includes trim around a periphery of at least one spherical lens and a band.

10. The eyewear device of claim 9, wherein the trim is formed of a gasket material and the band is formed of elastic.

11. The eyewear device of claim 1, wherein the at least one spherical lens is configured to be placed over an eyebrow of the wearer to enable the wearer interface to be located outside the field of view and thereby eliminate obstruction of the field of view.

12. The eyewear device of claim 1, wherein the substantially spherical surface is truncated to match contours of a face of the wearer.

13. The eyewear device of claim 1, wherein a diameter of the substantially spherical surface is selected to match contours of a face of the wearer.

14. The eyewear device of claim 1, further comprising:
a right spherical lens and a left spherical lens, wherein the right spherical lens and the left spherical lens are a hemispherical shape or a truncated portion thereof.

15. An eyewear system, comprising:
a non-transitory computer-readable medium, including facial analysis programming, wherein execution of the facial analysis programming by a processor configures a computing device to generate a facial profile of contours of a face of a wearer; and
an eyewear device including a first spherical lens and a second spherical lens, wherein the first spherical lens and the second spherical lens include a substantially spherical surface, are configured to maintain a substantially constant distance between an eyeball of a wearer and the substantially spherical surface to reduce distortion in positioning of objects in a field of view of the wearer, and are truncated to match the facial profile.

16. The eyewear system of claim 15, wherein the facial profile includes a geometry of one or more facial features of the wearer.

17. The eyewear system of claim 16, wherein the one or more facial features include spacing between eyes, nasal bridge width, or spacing between ears.

18. The eyewear system of claim 15, wherein the facial profile is a three-dimensional scanned facial profile or three-dimensional mesh.

19. The eyewear device of claim 15, wherein a diameter and a lens profile of the first spherical lens and the second spherical lens is selected to match the facial profile.

20. The eyewear system of claim 15, wherein the eyewear device further includes a wearer interface coupled to the first and second spherical lenses and configured to couple the first and second spherical lenses to a head of the wearer.

21.-25. (canceled)
